(19) United States
(12) Patent Application Publication
(10) Pub. No.: US 2012/0101729 A1
(43) Pub. Date: Apr. 26, 2012

(54) METHOD AND SYSTEM FOR DETECTING GROUND DISPLACEMENT

(76) Inventor: TAKAMUNE CHO, Morganville, NJ (US)

(21) Appl. No.: 13/272,179

(22) Filed: Oct. 12, 2011

Related U.S. Application Data
(60) Provisional application No. 61/406,138, filed on Oct. 24, 2010.

(51) Int. Cl. G06F 19/00

(52) U.S. Cl. 702/2

(57) ABSTRACT

Ground displacement detecting method and system are invented to save lives and properties. The system and method are quick, reliable, and cost-effective.

The system comprises one or more sensing units, optional supportive platforms, optional preprocessing units, and a main computer. A method is invented to determine ground displacement condition and the users can act accordingly.

The system checks all components' health status to optimize the reliability of the system and reduce the possibilities of the system failure.

The result of the system and the method provides the users with early opportunity to take proper actions to reduce the damages caused by the ground displacement.

### FIELD OF THE INVENTION

This invention relates generally to the detection of a ground displacement. A ground displacement includes, but not limited to, landslide, mudslide, avalanche, stream flow and other geo-displacement caused by external forces.

### BACKGROUND OF THE INVENTION

Inventors and researchers have tried to detect a ground displacement as early as possible. They used a wire connected between two remote stations. A ground displacement can be detected if the wire was broken by an external force. For this method, sometimes it is very hard to place wires at high altitude locations.

Another method uses an optical fiber to detect the light intensity and/or reflection at the receiving end to determine if a ground displacement has occurred. The change of the intensity is interpreted as the result of a ground displacement. Since an optical fiber needs to be laid out in the possible landslide area, the longer the optical fiber is used, the harder the maintenance becomes.

Another popular method uses a pole inserted into a hole bored in the ground. The pole contains traditional type of sensors consuming more electric power. Since the cost of the construction for setting up poles in displacement areas is expensive, some local government cannot afford this method. Also surveillance cameras can be used, but the cameras do not function well at night.

A better system and methods are needed to economically detect a ground displacement as early and accurately as possible.

### BRIEF SUMMARY OF THE INVENTION

This invention includes a system and methods for detecting a ground displacement. The approach is to invent a low cost, low power-consumption and more intelligent device with new methods to fully utilize motion sensors such as recent MEMS (MicroElectroMechanical Systems)-based motion sensors to build a system. Other types of motion sensors can also be used.

The system includes a sensing unit, an optional supportive platform, a preprocessing unit, and a main computer. The sensing unit is to detect any ground movement and passes the data to the preprocessing unit which decides if the ground movement is significant enough. The main computer collects the result from all the preprocessing units to determine if a ground displacement has occurred or not in the area covered by the system.

A device is defined as either the combination of the sensing unit, the supportive platform, and the preprocessing unit, or the combination of the sensing unit and the preprocessing unit.

A new method is invented to collect ground motion signals and determines when a ground displacement occurs by executing a ground displacement algorithm.

A method of health check for the system is invented to know when a repair maintenance is needed. The method will keep the system in operational situation so that it will continually provide with reliable detection of a ground displacement.

The system and methods are invented to detect a ground displacement as early and accurate as possible. The users of the system decide the criteria for the detection and will be notified once the criteria are met. The users can then proceed to take proper actions to reduce the damages caused by the ground displacement, such as sending out an alarm to allow early evacuation from the affected area. In this way, a lot of lives and properties can be saved.

### BRIEF DESCRIPTION OF THE DRAWINGS

FIG. 1 is an example of the sensing unit and the supportive platform in the system. It describes a pole structure. 101 is a half-cone shaped structure. The structure is made by a water/shock resistant material to protect MEMS sensors inside. MEMS sensors are wrapped by the structure. 102 is the MEMS gyroscope sensor. 103 is the MEMS accelerometer sensor. 104 is the MEMS inclinometer. Other types of motion sensors can be considered too. 105 is the supportive platform: a pole structure, which can be flexibly bent in any direction or a certain direction by external force, so that if a landslide or other ground displacement occurs, the pole is bent. The MEMS sensors on the top of the pole will sense the motion and send the signal via the supportive platform. 106 is an adaptor which connects to the supportive platform with a connector or a wired cable.

FIG. 2 is another example of the sensing unit and the supportive platform in the system. 201 is a structure made by a water/shock resistant material to protect MEMS sensors inside. MEMS sensors are wrapped by the structure. 202 is a MEMS gyroscope sensor. 203 is a MEMS accelerometer sensor. 204 is a MEMS inclinometer. Other types of motion sensors can also be applied. 205 is a supportive platform: a platform structure, made by a thin metal structure, which can be flexibly bent in any direction or a certain direction by external force, so that if a landslide or other ground displacement occurs, the platform is moved. The MEMS sensors on the top of the platform will sense the motion, and send the signal via the supportive platform. 206 is an adaptor which connects to the supportive platform with a connector or a wired cable.

FIG. 3 is an example of the preprocessing unit in a water/shock resistant box. The function of the preprocessing unit is mainly receiving data from the sensing unit, monitoring sensing unit healthiness, processing the data from sensing units and sending necessary data to the main computer where the ground displacement status is generated. 301 is a connector to connect to the sensing unit. 302 is an enclosed water/shock resistant box. 303 is a CPU. 304 is a ROM containing the software for the system. 305 is a battery. 306 is a GPS chip. Considering the power consumption, the GPS chip is optional. If a GPS chip is present, the positioning information can be obtained. 307 is a communication chip. Users can choose communication methods based on their needs and environmental restriction. 308 is an adaptor connecting to an external antenna. The external antenna is optional. 309 is a RAM containing the motion data and system log which will be sent to the main computer. 310 is an adaptor to connect to an external power supply such as a solar panel.

FIG. 4 to FIG. 12 describe how the sensing unit, the supportive platform and the preprocessing unit can be combined in different ways based on the user's needs and the environment of setup location.

FIG. 4 is an example of attaching the adaptor of the sensing unit directly on the top of the connector of the preprocessing unit. 401 is an external antenna for wireless communication purpose. 402 is a cable for the external antenna. 403 is a cable for connecting to an external power supply. 404 is an external power supply such as a solar panel.

FIG. 5 is an example illustrating that the preprocessing unit can be separated from the sensing unit and the supportive platform while cables are used to connect one another. In this embodiment, the preprocessing unit can be installed in a remote area. 501 is an external antenna for wireless communication purpose. 502 is a cable connecting the sensing unit, the supportive platform and the preprocessing unit. 503 is a cable for an external antenna. 504 is a cable for connecting to an external power supply. 505 is an external power supply such as a solar panel.

FIG. 6 is an example of attaching the adaptor of the supportive platform to the preprocessing unit directly. 601 is an external antenna for wireless communication purpose. 602 is a cable connecting the sensing unit, the supportive platform and the preprocessing unit. 603 is a cable for an external antenna. 604 is a cable for connecting to an external power supply. 605 is an external power supply such as a solar panel.

FIG. 7 is an example in which the sensing unit and the supportive platform can be installed upside down due to the difficulty of the installation. 701 is a supporter on the ground for sensing unit and the supportive platform. A cable 702 can be inserted inside of the supporter, and then connected to the preprocessing unit. 703 is an external antenna for wireless communication purpose. 704 is a cable for an external antenna. 705 is a cable for connecting to an external power supply. 706 is an external power supply such as a solar panel.

FIG. 8 is an example illustrating that the preprocessing unit can be expanded as a hub for multiple sensing units and supportive platforms. The preprocessing unit can be installed in a remote area. 801 is a cable connecting the sensing unit to the preprocessing unit. 802 is a cable for an external antenna. 803 is an external antenna. 804 is a cable connecting to an external power supply. 805 is an external power supply such as a solar panel.

FIG. 9 is an example illustrating that the sensing unit and the supportive platform can be installed beneath a bridge to detect if the speed of the river stream exceeds a threshold. Since the pole can be bent if the speed of the water flow is higher than the threshold, the signal is sent to the preprocessing unit via the cable.

FIG. 10 is another example of combining the sensing unit and the preprocessing unit into a water/shock resistant box without a supportive platform. 1001 are motion detective sensors. 1002 is an enclosed water/shock resistant box. 1003 is a CPU. 1004 is a ROM/RAM containing software. 1005 is a battery. 1006 is a GPS chip. Considering the power consumption, GPS is optional for the system. It is good to have GPS in the system, so that the positioning information can be included in the data. 1007 is a communication chip. Users can choose the communication methods based on their needs and environmental restriction. 1008 is an adaptor to connect to an external antenna. The external antenna is optional. 1009 is a RAM/ROM containing the motion data and system log which will be sent to the main computer. 1010 is an adaptor connecting to an external power supply such as a solar panel.

FIG. 11 is another example of the combination of the sensing unit, the supportive platform and the preprocessing unit. The platform structure described in FIG. 2 is used for the sensing unit and the supportive platform. A pole, 1106, is used to support the supportive platform. 1101 is a cable connecting the sensing unit, the supportive platform and the preprocessing unit. 1102 is a cable for an external antenna. 1103 is an external antenna. 1104 is a cable for connecting to an external power supply. 1105 is an external power supply such as a solar panel.

FIG. 12 is an example of one preprocessing unit serving as a hub connecting four sensing units with the supportive platforms. 1201 is a cable connecting the sensing unit and the preprocessing unit. 1202 is a cable for an external antenna. 1203 is an external antenna. 1204 is a cable connecting to an external power supply. 1205 is an external power supply such as a solar panel.

FIG. 13 is another example illustrating the sensing unit and the supportive platform. The sensing unit is a ball structure enclosing motion sensors. An elastic spring is used as the supportive platform to achieve additional sensitivity to movement. 1301 is a cable connecting the sensing unit and the preprocessing unit. 1302 is a cable for an external antenna. 1303 is an external antenna. 1304 is a cable for connecting to an external power supply. 1305 is an external power supply such as a solar panel.

FIG. 14 is an example of the system. In a potential ground displacement area, 8 devices (1401) are installed in places where are relatively sensitive to ground displacements. When a ground displacement occurs, the displacement will trigger the motion sensors in the sensing unit to transmit significantly different numeric data to the preprocessing unit. Those data are collected by the main computer (1404). The role of each device is equal, which means if any one of the devices is malfunctioning, there is only one location losing the trigger. The system will still be working properly. Also each sensing unit is assigned a weight based on its location. The weight is adjustable. Status data are obtained from all the sensing units and are transmitted to the preprocessing units periodically. The health check algorithm will be performed. Based on the health check result, the users will take proper actions such as replacing the battery or the malfunctioning unit. Once data from the sensors on the sensing unit are collected by the main computer, a ground displacement detection algorithm is executed. When the algorithm determines that a ground displacement has occurred, a displacement status is generated. The users can decide if a notification alarm will be sent out or not. The software updates (1405) can be uploaded via the communication method.

FIG. 15 is an example of a health check algorithm. The algorithm uses equations to calculate the total values of each status from all devices during a time series, to calculate the average values, and determines if the average values exceed the thresholds to decide the health of the system. The detail of the algorithm is discussed in a later section.

FIG. 16 is an example illustrating how the system determines to send out an alarm.

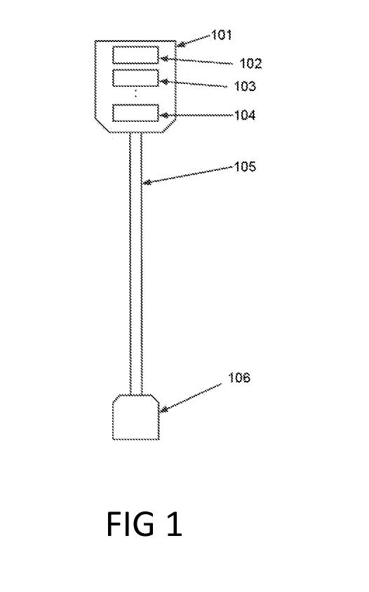

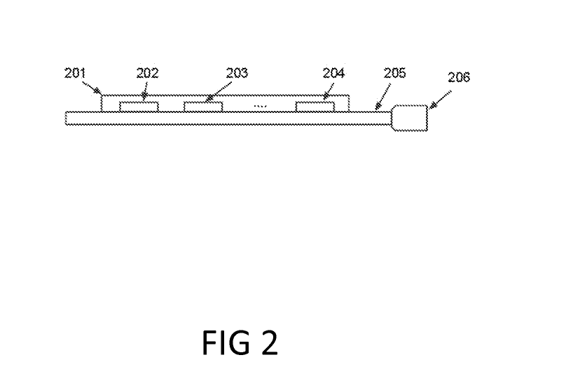

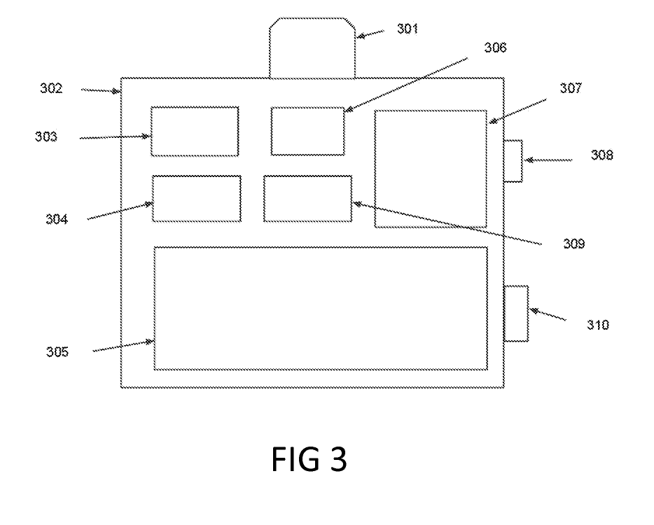

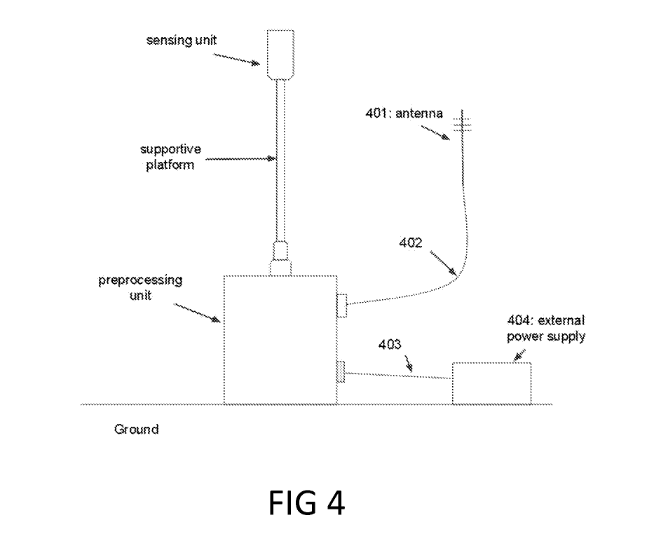

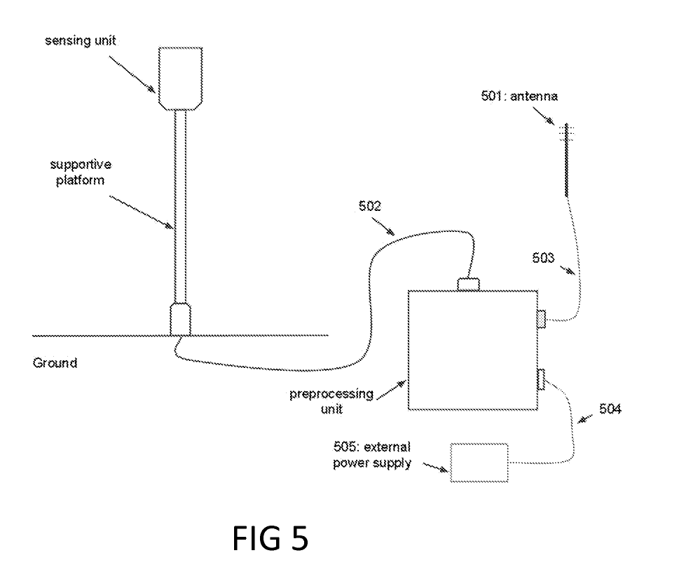

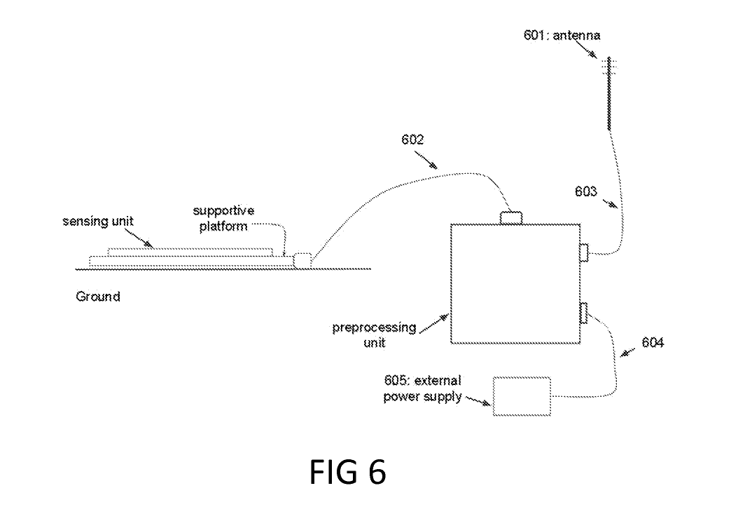

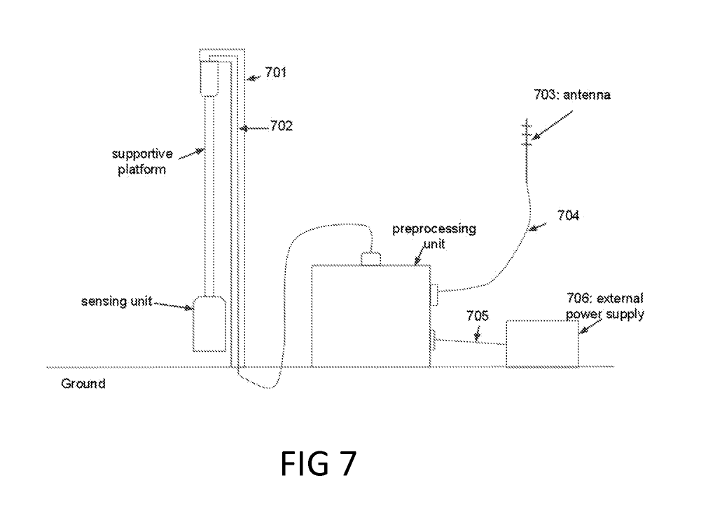

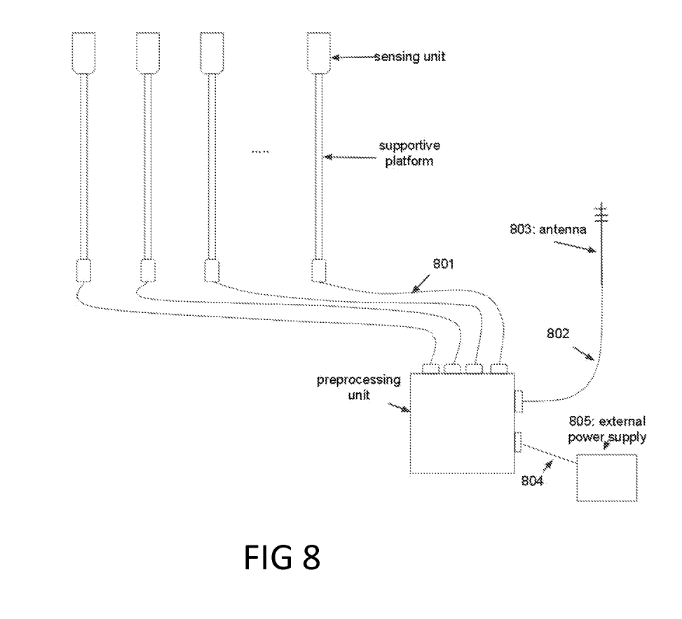

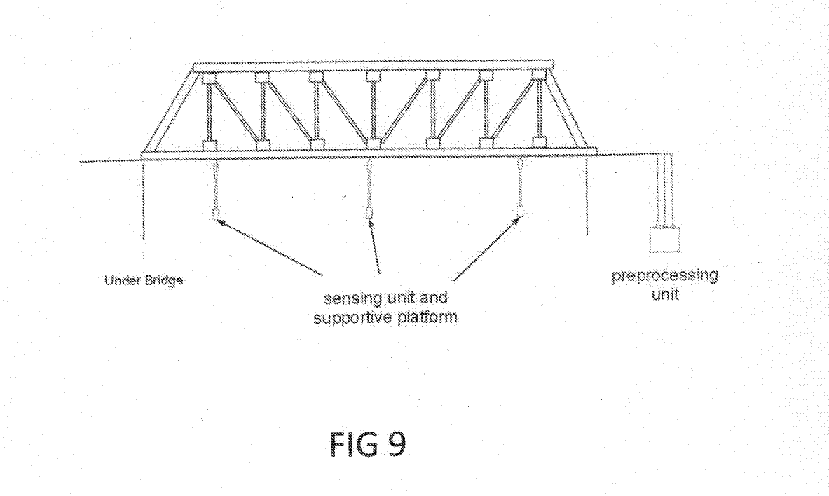

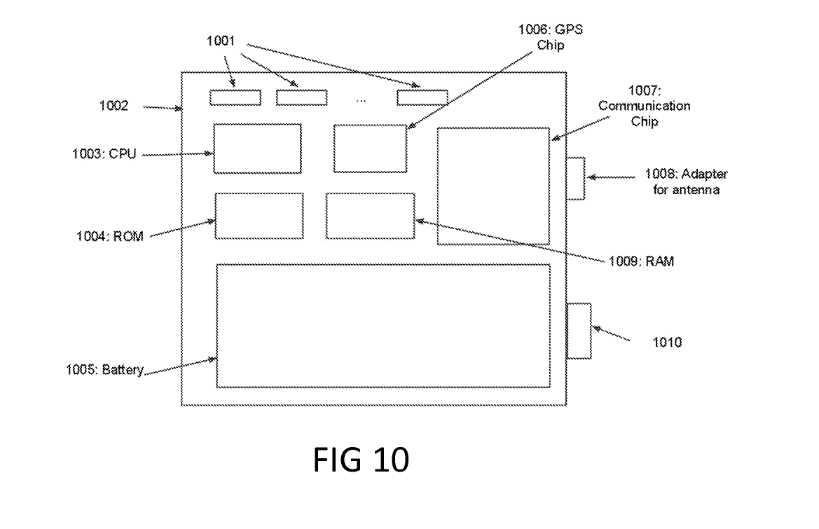

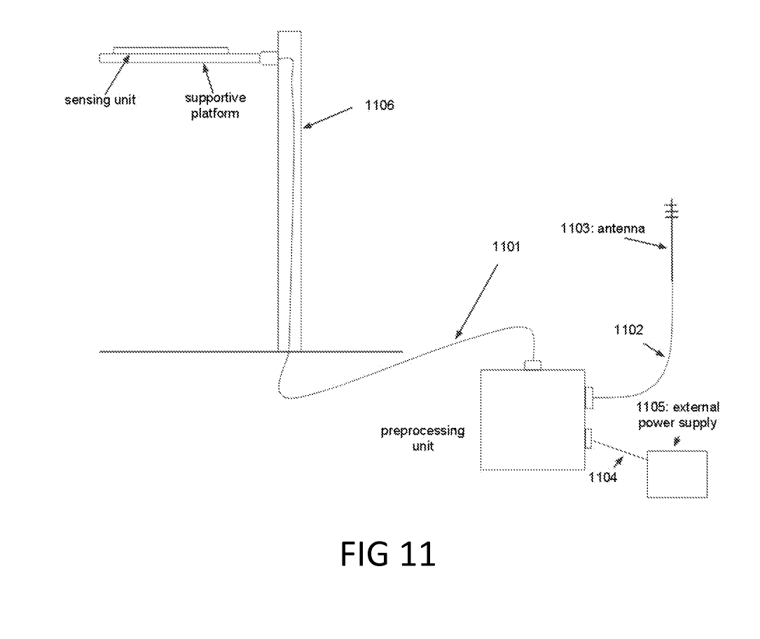

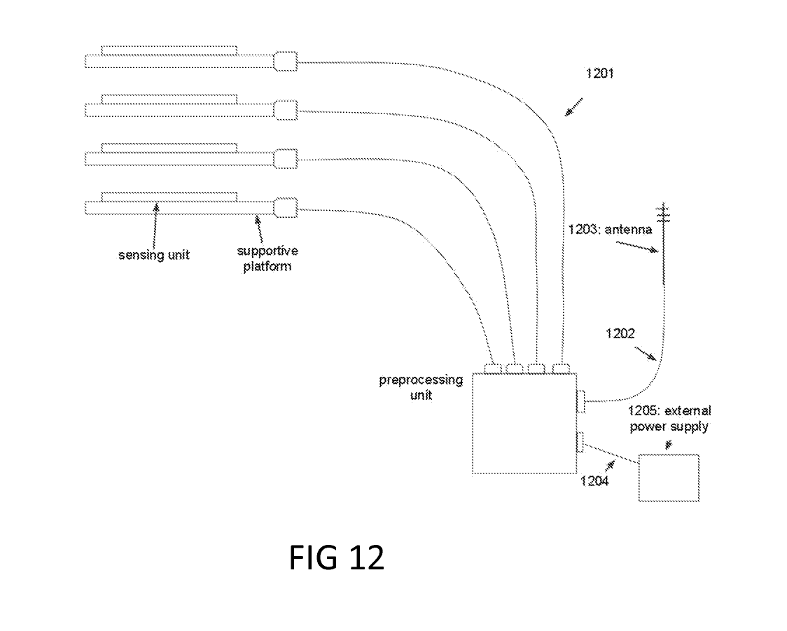

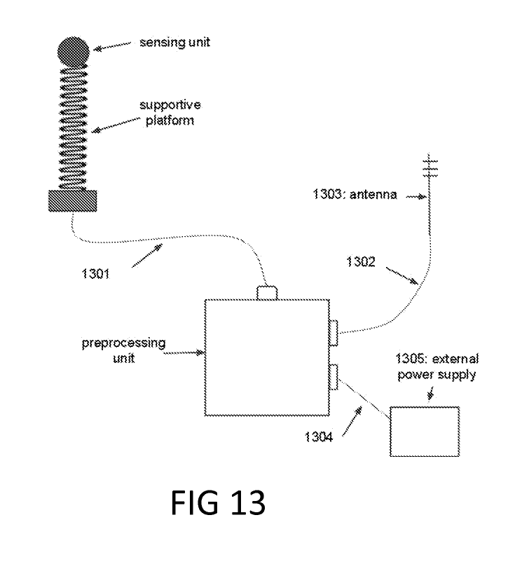

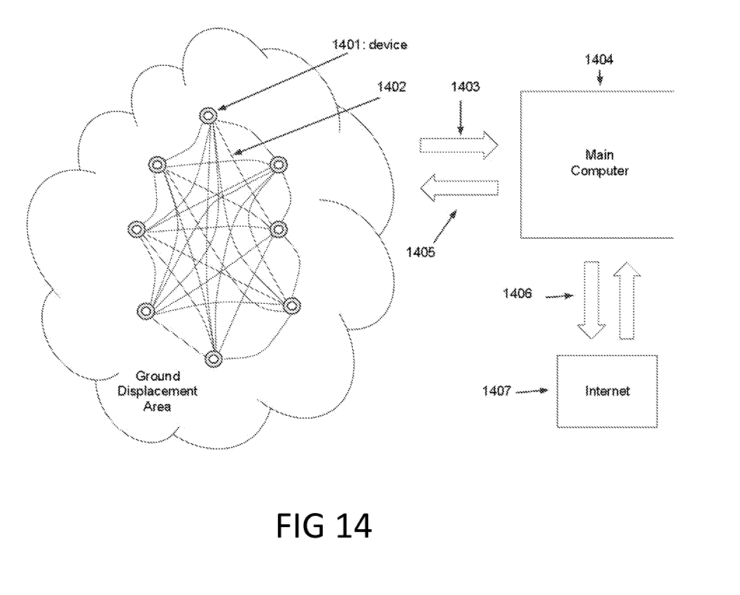

### DETAILED DESCRIPTION OF THE INVENTION

The invention is to detect a ground displacement as early as possible to save human lives and reduce the property damages. It uses electronic sensors to detect the ground motions and, with intelligent algorithms, decides if a ground displacement has occurred or not based on its user's criteria.

The system includes the following parts: a sensing unit, an optional supportive platform, a preprocessing unit, and a main computer. The sensing unit is a group of motion sensors which can be MEMS-based. The sensing unit detects the geographical displacement. Sensors like gyroscope, accelerometer, or inclination sensor can be considered. A supportive platform is optional. When a supportive platform is used, it supports the sensing unit. With a bendable supportive platform, the motion signals will be amplified when a ground displacement occurs. Examples of the supportive platform are, but not limited to, a pole, a flat platform and anything that can support the sensing unit. The preprocessing unit comprises a CPU, a memory unit, a communication unit and a battery. The preprocessing unit can be configured to support multiple sensing units. The main computer allows the users to configure the system and performs the function of deciding if a ground displacement has occurred or not.

The communication method among the parts of the system can be wired, wireless, or directly connected via adaptor. The signals from the sensing unit are transmitted to the preprocessing unit with or without the supportive platform. The parts of the system can be combined into one solid box. The combinations vary depending on the place where the system is installed and how it is used. For example, the sensing unit can be installed on the top of a pole which is a supportive platform and covered with water-proof and shock-resistant material. The sensing unit can contain MEMS-based sensors like gyroscope or accelerometer. The supportive platform, such as a pole, can be bent by external force and the change in signal strength of the motion sensors can be amplified.

A method of detecting a ground displacement is invented. When a ground motion occurs, the sensing unit and the supportive platform, if it is used, are affected by external forces. Those activities are sensed by the motion sensors in the sensing unit. The data are transmitted to the preprocessing unit. The preprocessing unit determines if a ground displacement has occurred, then sends a “yes or no” signal to the main computer. The determination of “yes or no” employs a numeric threshold. The value of the threshold is based on the characteristics of the motion sensors, such as accelerometer range or gyroscope range of sensitivity, adjustment of misalignment and bias for gyroscope, and accelerometer. The frequency of collecting the signals is called ‘data rate’ and is adjustable. One of the signal characteristics is dimension, such as 2-dimensional data or 3-dimensional data. We will call it ‘data dimension’. The data dimension is adjustable. Once the “yes or no” signals from all preprocessing units are collected by the main computer, the main computer executes a ground displacement algorithm to generate a ground displacement status to the users and to any target systems.

All parameters can be adjusted based on the environmental situation. The users can change the parameters and monitor the system from the main computer.

A method of health check for the system is invented. The health check method is based on statistics. All devices send out sensor and battery status. The status data are collected in the form of time series. Based on the data, a health check algorithm is executed per user-defined time period, for example, 10 minutes. The users will then be notified about the status of the system and can take the actions to repair the device. All parameters used for the health check can be adjusted from the main computer.

The system health check method is executed in the main computer. Each device α sends out c_{α}(t): connection status, b_{α}(t): battery indicator, and h_{α}(t): healthiness of sensor status to the main computer at certain time: t. The equations are:

$$C ( t ) = {\sum }_{a = 0}^{n - 1} {c}_{a} ( t )$$

$$B ( t ) = {\sum }_{a = 0}^{n - 1} {b}_{a} ( t )$$

$$H ( t ) = {\sum }_{a = 0}^{n - 1} {h}_{a} ( t )$$

In the equations, the total number of devices is n.

C(t), B(t), H(t) represent the total value of each status from all devices at time: t.

The main computer collects the status data between time T₀ and Tₛ₋₁; it then calculates the averages: AvgC₀, AvgB₀, AvgH₀.

$${AvgC}_{0} = \frac{{\sum }_{t = 0}^{s - 1} C ( t )}{S}$$

$${AvgB}_{0} = \frac{{\sum }_{t = 0}^{s - 1} B ( t )}{S}$$

$${AvgH}_{0} = \frac{{\sum }_{t = 0}^{s - 1} H ( t )}{S}$$

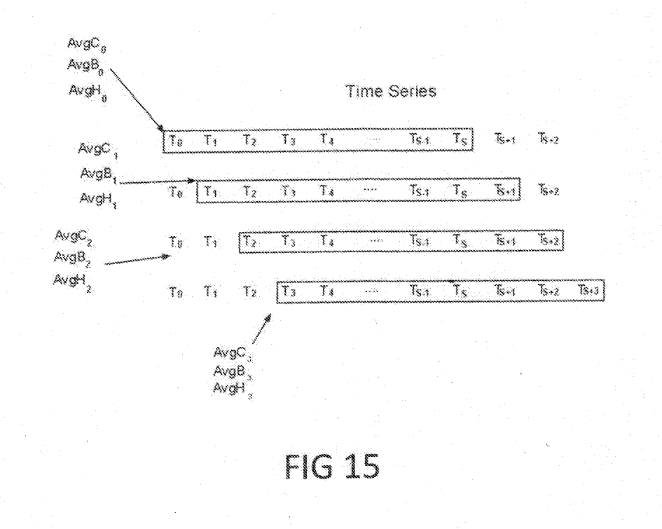

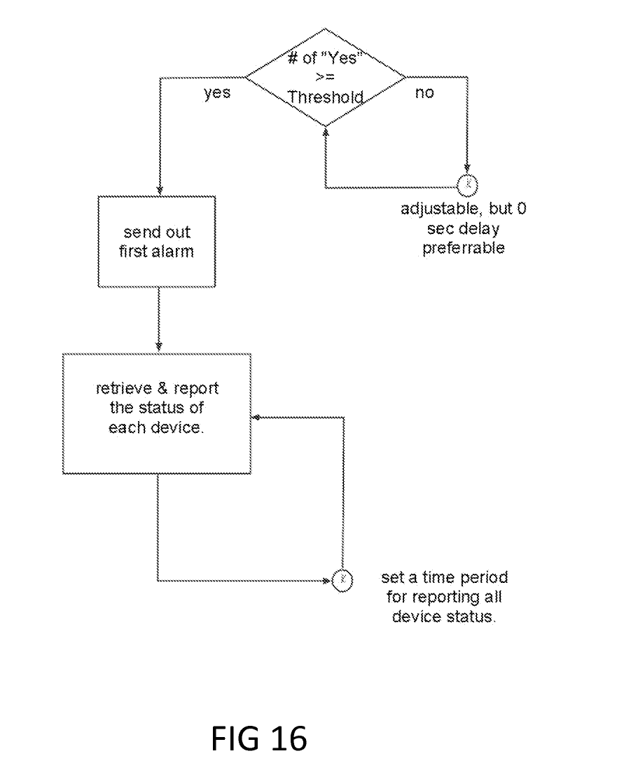

AvgC₀, AvgB₀, AvgH₀ represent the average value during the time period: T₀ and Tₛ₋₁ as shown in FIG. 15.

$$ResC = \frac{{\sum }_{c = 0}^{x - 1} {AvgC}_{c}}{X}$$

$$ResB = \frac{{\sum }_{c = 0}^{x - 1} {AvgB}_{c}}{X}$$

$$ResH = \frac{{\sum }_{c = 0}^{x - 1} {AvgH}_{c}}{X}$$

ResC represents the average value from AvgC₀ to AvgCₓ. ResB represents the average value from AvgB₀ to AvgBₓ. ResH represents the average value from AvgH₀ to AvgHₓ. The purpose of taking the average of the average of the status data within a time frame is to reduce the incorrect status collected by communication errors. In FIG. 15, X is equal to 3. Hence ResC, ResB and ResH is the average of the average for each status between the time: T₀ and Tₛ₊₂.

A threshold value for each status check: connection, battery and sensor is used to determine the healthiness of the system:

| | |
|---|---|
| ResC ≧ threshold C | Connection failure |
| ResB ≧ threshold B | Low battery |
| ResH ≧ threshold H | Sensor malfunction |

Since all status data between the time: T₀ and Tₛ₊₂ from all devices are stored in the main computer, once health check failure has been determined, it is easy to identify which device has sent the malfunctioning status to the main computer.

With motion sensors and reliable algorithms, a system and a method for detecting a ground displacement are invented. The system is easy to setup, cost-effective, and accurate.

What I claim is:

1. A method for detecting ground displacement, comprising the steps of:
deploying one or more sensing units at one or more locations, wherein each of said sensing units comprises one or more motion-detecting sensors;
repeatedly collecting motion signals detected by said sensing units; and
determining ground displacement condition of said locations in a main computer based on the collected motion signals over time.

2. The method of claim 1, further comprising:
deploying one or more preprocessing units at one or more locations;
connecting each of said preprocessing units to one or more said sensing units to repeatedly collect motion signals;
connecting each of said preprocessing units to said main computer;
In each said preprocessing unit, determining ground displacement condition of the location(s) of the sensing unit(s) it connects to based on the collected motion signals over time and sending the result to said main computer; and
in the main computer, determining ground displacement condition of the locations of all said sensing units using the result collected from the preprocessing units.

3. The method of claim 1, further comprising:
tuning one or more said motion-detecting sensors in at least one of the following:
range of sensitivity;
data rate; and
data dimension.

4. The method of claim 1, further comprising:
assigning weights to said sensing units in determining said ground displacement condition.

5. The method of claim 1, further comprising:
assigning weights to said motion-detecting sensors in determining said ground displacement condition.

6. The method of claim 1, further comprising:
discriminating ground displacement types using signal patterns of said motion signals collected from said motion sensors.

7. The method of claim 1, further comprising:
supporting one or more said sensing units with a structure such that said motion signals are amplified by the structure when ground displacement occurs.

8. The method of claim 1, further comprising:
identifying a malfunctioning unit among said motion sensors by comparing its motion signal with an expected norm, or by the absence of its motion signal.

9. A system for detecting ground displacement comprising:
one or more sensing units, wherein each of said sensing units comprises one or more motion-detecting sensors; and
a main computer for collecting motion signals from said sensing units and generating a ground displacement condition.

10. The system of claim 9, further comprising:
one or more preprocessing units, each connected to one or more said sensing units and the main computer, for processing the motion signals of the sensing units it connects to and relaying the result to the main computer.

11. The system of claim 9, further comprising:
one or more supportive platforms, wherein each of said supportive platforms supports one or more said sensing units and causes the motion signals to be amplified when a ground displacement occurs.

12. The system of claim 9, wherein said sensing unit further comprising:
means for obtaining its own geographic location.

13. The system of claim 9, wherein said main computer further comprising:
means for configuring parameters of said sensing units.

14. The system of claim 9, wherein said main computer further comprising:
means for configuring parameters of said preprocessing units.

15. The system of claim 9, wherein said main computer further comprising:
means for discriminating ground displacement types based on patterns of said motion signals.
